(19) United States
(12) Patent Application Publication
(10) Pub. No.: US 2016/0279836 A1
(43) Pub. Date: Sep. 29, 2016

(54) DEBURRING OF MOLDED PARTS, IN PARTICULAR RUBBER MOLDED PARTS

(71) Applicants: Ralf Schmand, Unterschleißheim (DE); Christian Bomm, Altenmunster (DE)

(72) Inventors: Ralf Schmand, Unterschleißheim (DE); Christian Bomm, Altenmunster (DE)

(21) Appl. No.: 15/077,994

(22) Filed: Mar. 23, 2016

(30) Foreign Application Priority Data
Mar. 26, 2015 (DE) 102015003942.3

(51) Int. Cl. B29C 37/02; B24C 1/00

(52) U.S. Cl. CPC B29C 37/02; B24C 1/003; B24C 1/006; B29K 2019/00

(57) ABSTRACT

A method for deburring a rubber molded part, by the following steps: providing a molded part that exhibits a bur to be removed, cooling the bur by exposing the bur to a liquefied gas, and exposing the bur to dry ice particles to remove the bur. There is also described a corresponding arrangement or apparatus for deburring rubber molded parts.

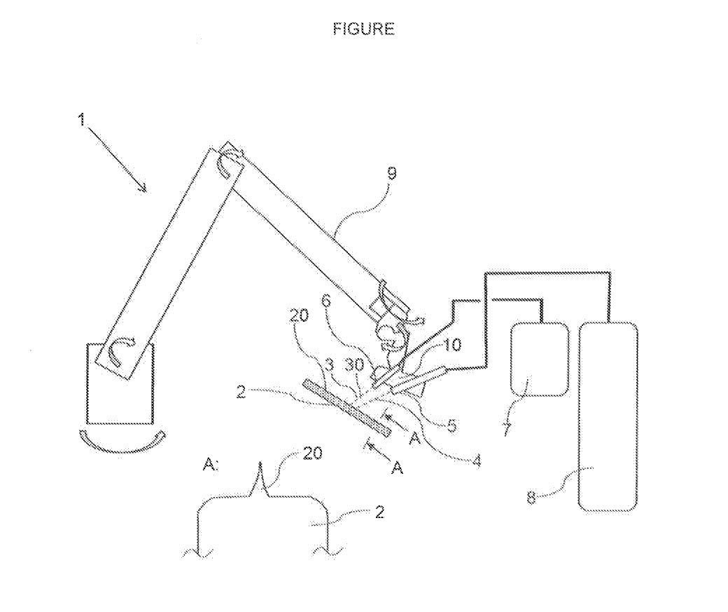

### CROSS REFERENCE TO RELATED APPLICATIONS

This application claims priority from German Patent Application DE 102015003942.3 filed on Mar. 26, 2015.

### BACKGROUND OF THE INVENTION

The invention relates to a method for deburring molded parts, in particular rubber molded parts. A rubber molded part is here understood as a molded part that exhibits a bur made out of rubber, which arises in particular during manufacture, e.g., injection molding, due to a separation of the casting tool or mold. Further understood in the sense of the present invention by the term rubber apart from natural rubber, in particular vulcanized rubber, as well as synthetic rubber, are all dimensionally stable, elastically deformable plastics, in particular elastomers (e.g., natural rubber or silicone rubber, see above), thermoplastic elastomers or thermoplastic materials, e.g., PPS.

As a rule, a mechanical removal of burs is performed for molded parts or rubber molded parts. Deburring is here often done by hand, e.g., with the assistance of tear-off tabs on the workpiece, knives or abrasives. This process is very time and personnel intensive.

### SUMMARY OF THE INVENTION

Proceeding from the above, the object of the present invention is to indicate a method and a device for debarring molded parts, in particular rubber molded parts, which diminishes the aforementioned disadvantages.

This object is achieved by a method for deburring a molded part comprising the following steps: Providing a molded part that exhibits a bur to be removed; Cooling the bur by exposing the bur to a liquefied gas; and Exposing the bur to dry ice particles to remove the bur.

Advantageous embodiments of the method according to the invention are indicated in the subclaims, and will be described below.

At least the following steps are provided according to one embodiment of the invention:

Providing a molded part that exhibits a bur to be removed,

Cooling the bur by exposing the bur to a liquefied gas, and

Exposing the bur to dry ice particles to remove the bur.

In particular, the molded part can involve a molded part made out of a rubber (see above) or a molded part made out of a thermoplastic material, in particular polyphenylene sulfide (PPS).

In a preferred embodiment of the method according to the invention, the dry ice particles, e.g., which can be generated as the product of a grated block of dry ice or other larger, scraped or ground dry ice products, can exhibit a diameter ranging from 1 μm to 5 mm, preferably ranging from 0.05 mm to 2 mm.

In an embodiment of the invention, dry ice snow can be used as the dry ice particles. The particle size for dry ice snow preferably ranges between 1 μm and 500 μm, in particular from 30 μm to 300 μm.

In another embodiment of the invention, dry ice particles can be used in the form of dry ice pellets. The particle size for dry ice pellets preferably ranges from 0.3 mm to 5 mm, in particular from 1 mm to 5 mm, in particular from 1 mm to 3 mm.

For example, grated dry ice can also be used in an embodiment of the invention, which is grated from a dry ice block, wherein in particular the size of the dry ice particles ranges from 0.1 mm to 1 mm.

Depending on the pelletizer, the dry ice pellets further preferably exhibit a density ranging from 1.4 g/cm³ to 1.7 g/cm³, in particular of approx. 1.56 g/cm³, and preferably a Mohs hardness ranging from approx. 1 to 3.

In addition, the dry ice particles (e.g., dry ice pellets) are preferably fired at the bur at a speed ranging from 80 to 350 m/s. The dry ice particles are here preferably fired at the bur with a carrier gas, in particular compressed air.

By applying cod, liquefied gas, the molded part is ideally brought to temperatures of around the glass transition temperature of the material of the molded part to be deburred. This at least elevates the stiffness of the bur.

The dry ice particles are used to mechanically remove the bur of the molded part that was made brittle by the precooling. The pulse of the individual dry ice particles (e.g., dry ice pellets) here plays a role. The latter is determined by the speed along with the size and density of the dry ice particles, or by the mass thereof.

In addition, the dry ice particles also transfer heat from the bur into the respective particle as they strike the bur, thereby giving rise to a pronounced temperature gradient and correspondingly high shear forces in the bur, which help to remove the bur.

Finally, the sublimation of dry ice particles (e.g., dry ice pellets) gives rise to gaseous CO₂ upon impingement, which takes up significantly more volume by comparison to solid dry ice particles. This explosive increase in volume also imparts a pulse into the bur at the point of impact, which helps to remove the bur.

One advantage to the method according to the invention in particular is that not just the bur of the molded part is removed, but the molded part is simultaneously cleaned by exposure to the dry ice particles.

In another preferred embodiment of the method according to the invention, the liquefied gas used to precool or embrittle the bur is liquid nitrogen.

Another preferred embodiment of the method according to the invention provides that the bur is exposed to the liquefied gas by moving a spray nozzle along the bur, in particular automatically, and spraying the liquefied gas onto the bur with the spray nozzle.

Another preferred embodiment of the method according to the invention provides the bur is exposed to the dry ice particles (e.g., dry ice pellets) by moving a CO₂ nozzle along the bur and firing the dry ice particles at the bur with the CO₂ nozzle.

The problem underlying the invention is further resolved with a device for deburring molded parts, in particular rubber molded parts by an arrangement or apparatus for deburring molded parts, comprising

a means configured to expose the bur to be removed to a liquefied gas, and

a CO₂ nozzle configured to fire dry ice particles at the bur.

According to the latter, the deburring device according to the invention exhibits a means configured to expose the bur to be removed to a liquefied gas, in particular to precool or embrittle the bur, as well as a CO₂ nozzle set up to fire dry ice particles (e.g., dry ice pellets) at the bur.

For example, the means for exposing the bur to a liquefied gas (in particular liquid nitrogen, see above) can exhibit a spray nozzle, which is configured to spray the liquefied gas on the bur to be removed.

A preferred embodiment of the arrangement according to the invention further provides that the arrangement exhibit a device designed to store and/or generate the dry ice particles, wherein the device is preferably fluidically connected with the CO₂ nozzle, so that dry ice particles stored and/or generated in the device can be fired at the bur via the CO₂ nozzle. The device is preferably designed to accelerate the dry ice particles toward the bur by means of a carrier gas, in particular compressed air.

It is further preferably provided that the arrangement exhibit a guide designed to move the CO₂ nozzle along the bur to be removed. The arrangement is preferably configured to here expose the bur to the dry ice particles. In the process, the CO₂ nozzle preferably traverses the bur at a constant distance from the bur.

The guide can be designed to move the aforesaid spray nozzle along the bur to be removed. The arrangement is preferably configured to here spray the bur with the liquefied gas (e.g., nitrogen). The spray nozzle here also preferably traverses the bur at a constant distance from the bur.

Naturally, separate guides can also be provided for the spray nozzle and CO₂ nozzle.

### BRIEF DESCRIPTION OF THE DRAWINGS

In the figure description of embodiments of the invention, additional features and advantages will be described below based on the figure. Shown on:

The FIGURE is a schematic illustration of an arrangement according to the invention or a method according to the invention for deburring a molded part, in particular a rubber molded part.

### DETAILED DESCRIPTION OF THE INVENTION

The FIGURE shows an arrangement 1 for deburring a molded part 2, in particular in the form of a rubber molded part 2, which here is held fast by a suitable retaining device (not shown). The molded part 2 exhibits a bur 20, which extends along the molded part 2 (see detail A) and is to be removed.

To this end, the arrangement 1 exhibits a spray nozzle 5, which is connected in terms of flow with a storage tank 8, and stores a liquefied gas 4, in particular, nitrogen.

For example, a carrier 10 couples the spray nozzle 5 with a guide 9, here in the form of a robot arm, which is designed to three dimensionally position the spray nozzle 5 in space. Other guides are also conceivable, even manual ones.

The guide 9 can interact with a control or regulating unit, which regulates the guide 9 in such a way as that the spray nozzle 5 is automatically moved along the bur 20, wherein the spray nozzle 5 preferably maintains an essentially constant distance from the bur.

The arrangement 1 further exhibits a CO₂ nozzle 6 for removing the bur 20, which is fluidically connected with a device 7 for storing and/or generating dry ice pellets 3. The device 7 is designed to eject the dry ice particles (e.g., dry ice pellets) 3 from the CO₂ nozzle 6 by means of a carrier gas 30 and fire them at the bur 20.

The CO₂ nozzle 6 is here also coupled with the guide 9 (e.g., via the carrier 10), wherein the guide 9 is once again designed to three dimensionally position the CO₂ nozzle 6 in space. The control or regulating unit here regulates the guide 9 in such a way that the CO₂ nozzle 6 is automatically moved along the bur 20, wherein the latter is sprayed with a liquefied gas 4, preferably liquid nitrogen 4, so as to make the bur 20 brittle.

In order to remove the bur 20 of the molded part, for example which can be a passenger car gasket, the spray nozzle 5 is now first moved along the bur 20, wherein the latter is sprayed with a liquefied gas 4, preferably liquid nitrogen 4, so as to make the bur 20 brittle,

In a separate process, the CO₂ nozzle 6 can be guided along the bur 20 with the guide 9, so as to fire dry ice particles or pellets 3 at the bur 20. However, it is also conceivable to move the spray nozzle 5 and CO₂ nozzle 6 together along the bur 20 in a single process, wherein the spray nozzle 5 first sprays liquefied gas 4 onto the respective bur section, after which the bur embrittled in this way is bombarded with dry ice particles or pellets 3, and the bur 20 is mechanically removed section by section in the process. The CO₂ nozzle 6 here moves behind the spray nozzle 5. This can be realized by rigidly fixing the two nozzles 5, 6 to the carrier 10, for example, and moving the latter along the bur 20 by means of the guide 9, wherein the spray nozzle 5 is situated in front of the CO₂ nozzle 6 in the direction of movement, i.e., trails behind the spray nozzle 5.

### EXAMPLE

In an example of the method according to the invention, the pressure of the used compressed air (carrier gas 30) measures 6 bar at about 0.15 kg/min. The dry ice pellets 3 (0.5 kg in all) are fired at the bur 20 made brittle beforehand with liquid nitrogen (1.3 kg/min). The liquid nitrogen here exhibits a pressure of 1.5 bar, and is relayed through an approx. 1.5 m long hose with a nominal width of 6 mm to a spray nozzle, which is provided with a mouth with a diameter of 2.5 mm. The treatment time for removing the roughly 0.5 m long bur 20 here lasts about 30 to 40 seconds without handling times. The two nozzles 5, 6 are moved at a speed of about 1 to 2 m/min. The parameters specified here are only an example, with other process conditions and parameters also being possible.

Reference List

| | |
|---|---|
| 1 | Arrangement |
| 2 | Molded part |
| 3 | Dry ice particles |
| 4 | Liquefied gas |
| 5 | Spray nozzle |
| 6 | CO₂ nozzle |
| 7 | Device |
| 8 | Storage tank |
| 9 | Guide |
| 10 | Carrier |
| 20 | Bur |
| 30 | Carrier gas (e.g., compressed air) |

What we claim is:

1. A method for deburring a molded part comprising the steps:
Providing a molded part that exhibits a bur to be removed,
Cooling the bur by exposing the bur to a liquefied gas, and
Exposing the bur to dry ice particles to remove the bur.

2. The method according to claim 1, characterized in that the dry ice particles comprises a diameter ranging from 1 μm to 5 mm.

3. The method according to claim 1, characterized in that the dry ice particles comprises a diameter ranging from 0.05 mm to 2 mm.

4. The method according to claim 1, characterized in that the dry ice particles comprises a density ranging from 1.4 g/cm³ to 1.7 g/cm³.

5. The method according to claim 1, characterized in that the dry ice particles are fired at the bur at a speed ranging from 80 to 350 m/s.

6. The method according to claim 1, characterized in that the dry ice particles are fired at the bur with a carrier gas.

7. The method according to claim 6, characterized in that the carrier gas is compressed air.

8. The method according to claim 1, characterized in that the liquefied gas is liquid nitrogen.

9. The method according to claim 1, characterized in that the bur is exposed to the liquefied gas by moving a spray nozzle along the bur and spraying the liquefied gas onto the bur with the spray nozzle.

10. The method according to claim 9, characterized in that the spray nozzle is moved along the bur automatically.

11. The method according to claim 1, characterized in that the bur is exposed to the dry ice particles by moving a CO₂ nozzle along the bur and firing the dry ice particles at the bur with the CO₂ nozzle.

12. An arrangement for debarring molded parts, comprising
a means configured to expose the bur to be removed to a liquefied gas, and
a CO₂ nozzle configured to fire dry ice particles at the bur.

13. The arrangement according to claim 12, characterized in that the arrangement comprises a device for storing and/or generating the dry ice particles, wherein the device is connected with the CO₂ nozzle, so that dry ice particles stored and/or generated in the device can be fired at the bur via the CO₂ nozzle.

14. The arrangement according to claim 13, characterized in that the device is designed to fire the dry ice particles at the bur by means of a carrier gas.

15. The arrangement according to claim 14, characterized in that the carrier gas is compressed air.

16. The arrangement according to claim 12, characterized in that the arrangement comprises a guide designed to move the CO₂ nozzle along the bur to be removed.
